(19) United States
(12) Patent Application Publication
(10) Pub. No.: US 2010/0196815 A1
(43) Pub. Date: Aug. 5, 2010

(54) ELECTROSTATIC CHARGE IMAGE DEVELOPING TONER

(75) Inventors: Kai Schumacher, Hofheim (DE); Paul Brandl, Shanghai (CN); Akira Inoue, Yokkaichi Mie (JP); Yuki Amano, Yokkaichi Mie (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: EVONIK DEGUSSA GMBH, Essen (DE)

(21) Appl. No.: 12/532,852

(22) PCT Filed: Mar. 27, 2007
(86) PCT No.: PCT/EP07/52931

§ 371 Date: Jan. 19, 2010

(51) Int. Cl. G03G 9/08

(52) U.S. Cl. 430/108.6

(57) ABSTRACT

Electrostatic charge image developing toner Electrostatic charge image developing toner containing external additives comprising pyrogenically prepared surface modified silicon-dioxide-titanium mixed oxides.

The present invention relates to an electrostatic charge image developing toner.

A compact type printer of the electrophotographic method operating at low cost, accompanied with improved image performance via high resolution, has recently been desired. On the one hand, a toner having a small particle diameter has been utilized due to customer demand for the foregoing image quality.

In order to realize a compact printer at low cost, structure members of a developing apparatus and the apparatus configuration itself are to be simplified, or the number of parts are considered to be reduced. As a result, by an amount equivalent to the simplification of an apparatus, it was particularly difficult to adjust and control temperature and humidity, and process correction. Similarly to a toner transport system and a toner supply system, a toner itself was also desired to be improved in order to transport a toner smoothly.

When a toner having a small particle diameter is used for an apparatus, and the toner remains unused for a couple of days with no operation of the apparatus, the interparticle density is increased, whereby the fluidity tends to be markedly lowered, which is also called “packing”.

A technique to counter the above problem is to provide external additives, for which acicular titanium and titanium-enclosing silica are used as a method of improving toner transportability.

It is also reported that a toner into which such external additives are added exhibits excellent image transfer and image improvement.

However, these external additives are easily influenced by the image forming environment, and variation in charging tends to be dependent on the environment such as temperature and humidity, whereby variation in image density depending on the image forming environment has been unavoidable. Accordingly, application to the above printer accompanied with the simplified apparatus configuration was considered to be extremely difficult.

As described before, since the above printer is usually used at home or in small offices, in such the environment the printer tends to be left with no operation for a long time. Accordingly, when the printer is used after a long interval, toner transportability is seriously lowered, whereby problems such as appearance of a low density image caused by no predetermined amount of toner supplied to a developing portion, and the like have easily been produced.

It is known to use an electrostatic charge image developing toner containing external additives comprising at least amorphous silica and crystallized metal oxide selected from titanium oxide, aluminium oxide, zirconium oxide or calcium oxide, wherein the amorphous silica is present on the crystallized metal oxide (US 2006/0204879 A1).

It is an object of the present invention to provide an electrostatic charge image developing toner which is capable of image forming stably with no influence from the installation environment of an image forming apparatus.

Still, it is also an object of the present invention to provide not only a toner capable of exhibiting no variation in charging via the installation environment as well as variation in temperature and humidity in the interior of an apparatus, but also a toner capable of receiving no occurrence of “packing”, even though the apparatus has not been operated for a long period of time.

Still, it is an object of the present invention to provide an electrostatic charge image developing toner capable of forming stable images for a low cost compact printer which is designed with a reduced number of parts and a simple structure of the overall apparatus.

The subject of the invention is an electrostatic charge image developing toner containing external additives comprising, pyrogenically prepared surface modified silicon dioxide-titanium mixed oxides.

It is found that a toner containing external additives according to the invention can inhibit lowering of the amount of charge at high-temperature and humidity such as 30° C. and 80% RH, or at low-temperature and humidity such as 10° C. and 20% RH. Though the reason why such an effect occurs in a toner containing the above external additives is not clear, it is presumed to be caused by an electrical property of the above external additives.

When the amount of charge exceeds a certain level, charges move from the external additive surface to the nucleus at low-temperature and humidity, under which an excessive amount of charge tends to remain on the external additive surface, whereby the charge density basically remains constant. Thus, charge leakage caused by humidity or moisture on the crystallized metal oxide surface occurs at high-temperature and humidity, and this charge is then supplied to the external additive surface, whereby the charge density on the surface basically remains constant.

Toner fluidity is presumably considered to be improved, since amorphous silica is present on the metal oxide surface in the external additive. As a result, even though toner “packing” is caused by no operation of an image forming apparatus for a long period of time, toner transportability may not be degraded since toner fluidity is improved. Since developing torque necessary for toner transport is also lowered due to improved toner fluidity, wasteful electrical power consumption is reduced, so that no burden is presumably applied to the toner transporting and driving members.

It is also assumed that the releasing of external additives from a toner, caused by toner-to-toner contact or collision rarely occurs, since the burden is reduced in the case of the improved toner fluidity even though toner-to-toner contact occurs during transporting of the toner. As a result, toner cleaning property is improved, so that an excellent cleaning performance is expected with existing cleaning apparatus.

An electric dipole is formed on the toner surface by using a resin an ionic dissociative group which resin is derived from monomers having the ionic dissociative group such as acrylic acid, methacrylic acid, or the like, as a binder resin constituting a base material of toner, whereby external additives adhere firmly to the toner surface. As a result, since external additives are retained on the toner surface with no penetration of external additives into the toner interior or with no releasing of external additives from the toner surface, toner charging property is controlled in a balanced manner, whereby toner charging performance is maintained with no influence from the ambient environment.

The problem of the invention is to make a toner composition, which shows an excellent charging stability at higher temperature and high humidity of the environment and/or at low temperatures and low humidity of the environment.

The subject of the invention is an electrostatic charge image developing toner containing external additives comprising pyrogenically prepared surface modified silicon dioxide-titanium dioxide mixed oxides.

The amount of the external additives added to a toner base material can be 0.1-6% by weight, based on the toner base material.

The pyrogenically prepared surface-modified silicondioxide-titanium dioxide mixed oxide can be a surface modified, pyrogenically prepared titanium dioxides coated with silicon dioxide.

The surface-modified, pyrogenically prepared titanium dioxides coated with silicon dioxide can be prepared by spraying titanium dioxides prepared by flame hydrolysis and coated with silicon dioxide with the surface-modifying agent and tempering the surface modified silicon dioxide coated titanium dioxides.

Furtheron, the surface-modified, pyrogenically prepared titanium dioxides coated with silicon dioxide can be prepared by treating the titanium dioxides prepared by flame hydrolysis and coated with silicon dioxide with the surface-modifying agent in vapour form and then heat treated.

The invention uses pyrogenically prepared surface-modified silicon dioxide-titanium dioxide mixed oxides. The surface modification can consist substantially of SiO—R-Groups, formed from the corresponding starting materials. Alkoxy groups from starting materials (surface-modifying agents) can be present. The surface modification according to the invention may be complete or partial. In addition, the surface-modified pyrogenically prepared silicon dioxide-titanium dioxide mixed oxides according to the invention have a hydrophobic nature.

As pyrogenically prepared silicon dioxide-titanium dioxide mixed oxides there may be used in principle any pyrogenically prepared silicon dioxide-titanium dioxide mixed oxides.

These mixed oxides can show a content of SiO₂ of 0.1 to 99.9 wt.-%. Furtheron they can have a BET-surface of 1 to 400 m²/g.

There may be used in particular, for example:

a titanium dioxide mixed oxide prepared by flame hydrolysis, that is to say pyrogenically, having a BET surface area of from 10 to 150 m²/g, which comprises from 1 to 30 wt.-% silicon dioxide as constituent of the mixed oxide.

It is known from DE 4235996, a silicon-titanium dioxide mixed oxide powder prepared by flame hydrolysis, which consists of aggregates of primary particles, characterised in that the BET surface area is 90+−15 m²/g, the titanium dioxide content is 50+−8 wt.-%, the anatase/rutile ratio is from 60:40 to 70:30.

This silicon dioxide-titanium dioxide mixed oxide powder is known from DE 102004024500.2.

A powder consisting of particles having a core of titanium dioxide and a shell of silicon dioxide, which is characterised in that it has a content of silicon dioxide of from 0.5 to 40 wt. %, a BET surface area of from 5 to 300 m²/g and consists of primary particles that have a shell of silicon dioxide and a core of titanium dioxide. This silicon dioxide-titanium dioxide mixed oxide is known from WO 2004/056927.

Accordingly, it is possible to use a powder consisting of particles having a core of titanium dioxide and a shell of silicon dioxide, which powder is characterised in that it comprises an amount of silicon dioxide of from 0.5 to 40 wt.-%, it has a BET surface area of from 5 to 300 m²/g, and it consists of primary particles that have a shell of silicon dioxide and a core of titanium dioxide.

The amount of silicon dioxide in the powder according to the invention is from 0.5 to 40 wt. %. With values below 0.5 wt. %, a completely closed silicon dioxide shell is not ensured.

The BET surface area of the powder according to the invention is determined in accordance with DIN 66131.

Primary particles are to be understood as being very small particles which cannot be split up further without breaking chemical bonds. These primary particles can grow together to form aggregates. Aggregates are distinguished by the fact that their surface area is smaller than the sum of the surface areas of the primary particles of which they consist. Furthermore, aggregates are not divided completely into primary particles on dispersion. Powders according to the invention having a low BET surface area may be present wholly or predominantly in the form of non-aggregated primary particles, while powders according to the invention having a high BET surface area have a higher degree of aggregation or are in completely aggregated form. Preferably, the aggregates consist of primary particles which have grown together via their silicon dioxide shells. Powders according to the invention based on such an aggregate structure exhibit particularly good effect as external additive of a toner. More preferably, the powder according to the invention can have a silicon dioxide content of from 1 to 20 wt.-%.

The ratio of the rutile/anatase modifications of the titanium dioxide core of the powder according to the invention can be varied within wide limits. For example, the ratio of the rutile/anatase modifications may be from 1:99 to 99:1, preferably from 10:90 to 90:10.

With the wide limits of the rutile/anatase modifications ratio, together with the silicon dioxide content of the shell, it is possible to select, for example, powders for application in toners in a targeted manner.

The preparation of the surface-modified silicon dioxide-titanium dioxide mixed oxides can be done as follows: In a mixer, the pyrogenically prepared silicon dioxide-titanium dioxide mixed oxides can be optionally first sprayed with water and then with the surface-modifying agent and then optionally mixed, and the resulting mixture is tempered. The water that is used can be acidified with an acid, for example hydrochloric acid, to a pH value of from 7 to 1. The water that is used can be rendered alkaline with a lye to a pH value of from 7 to 14. If a plurality of surface-modifying agents are used, these can be applied together, but separately, in succession or in the form of a mixture.

The surface-modifying agent(s) can be dissolved in suitable solvents. When the spraying is complete, mixing can be carried out for from 5 to 30 minutes. The mixture is then subjected to heat treatment at a temperature of from 20 to 400° C. for a period of from 1 min. to 6 hours. The heat treatment can be carried out under protecting gas, such as, for example, nitrogen.

An alternative method for the surface modification of the pyrogenically prepared silicon dioxide-titanium dioxide mixed oxides can be carried out by treating the pyrogenically prepared silicon dioxide-titanium dioxide mixed oxides with the surface-modifying agent in vapour form and then subjecting the mixture to heat treatment.

The heat treatment can be carried out at a temperature of from 50 to 800° C. for a period of from 1 min. to 6 hours. The heat treatment can be carried out under protecting gas, such as, for example, nitrogen. It can also be carried out in a plurality of steps at different temperatures.

The application of the surface-modifying agent(s) can be carried out by means of single-component, two-component or ultrasonic nozzles.

The surface modification can be carried out continuously or batchwise in heatable mixers and driers having spray devices. Suitable devices may be, for example: ploughshare mixers, disk, fluidised bed or fixed bed driers.

When the heat treatment is complete, the oxides according to the invention can be ground. To this end, pinned disk, toothed disk or jet mills can be used.

The powder according to the invention can have a BET surface area of preferably from 1 to 300 m²/g, particularly preferably from 10 to 150 m²/g, especially 30 to 100 m²/g.

As surface-modifying agents (individual or a plurality) there may be used silicas or organosilanes of the general formula: Si(OR)ₓ(OR′)_{y}(OR″)ᵤ(OR″′)ᵥ.

### X=0, 1, 2, 3, 4

y=0, 1, 2, 3, 4
u=0, 1, 2, 3, 4
v=0, 1, 2, 3, 4
x+y+u+v=4
R=alkyl, such as methyl, ethyl, propyl . . .
R′=alkyl, such as methyl, ethyl, propyl . . .
R″=alkyl, such as methyl, ethyl, propyl . . .
R″′=alkyl, such as methyl, ethyl, propyl . . .

It is also possible to use silanes which are formed by the partial hydrolysis and condensation of silanes of type Si(OR)ₓ(OR′)_{y}(OR″)ᵤ(OR′″)ᵥ (as described above), such as, for example, (CH₃CH₂O)₃SiOSi(CH₃CH₂O)₃. Such hydrolysis and condensation products can be prepared by oneself or acquired commercially, such as, for example, DYNASIL® 40 (Degussa GmbH). Preference is given to the use of tetramethoxysilane and tetraethoxysilane.

The invention uses furtheron as surface-modified SiO₂/TiO₂-mixed oxide surface-modified, pyrogenically prepared titanium dioxides coated with silicon dioxide.

The preparation of the surface-modified, pyrogenically prepared titanium dioxides coated with silicon dioxide can be done by a method, wherein the titanium dioxide prepared by flame hydrolysis and coated with silicon dioxide are optionally first sprayed with water and then with the surface-modifying agent and are subsequently tempered.

The water that is used can be acidified with an acid, for example hydrochloric acid, to a pH value of from 7 to 1. The water that is used can be rendered alkaline with a lye to a pH value of from 7 to 14.

If a plurality of surface-modifying agents are used, these can be applied together, but separately, in succession or in the form of a mixture.

The surface-modifying agent(s) can be dissolved in suitable solvents. When the spraying is complete, mixing can be carried out for from 1 to 30 minutes.

The mixture is then subjected to heat treatment at a temperature of from 20 to 400° C. for a period of from 1 minute to 6 hours. The heat treatment can be carried out under protecting gas, such as, for example, nitrogen.

An alternative method for the surface modification of the titanium dioxides prepared by flame hydrolysis and coated with silicon dioxide can be carried out by treating the titanium dioxides prepared by flame hydrolysis and coated with silicon dioxide with the surface-modifying agent in vapour form and then carrying out heat treatment. The heat treatment can be carried out at a temperature of from 50 to 800° C. for a period of from 1 min. to 6 hours. The heat treatment can be carried out under protecting gas, such as, for example, nitrogen. The heat treatment can also be carried out in a plurality of steps at different temperatures.

The application of the surface-modifying agent(s) can be carried out by means of single-component, two-component or ultrasonic nozzles.

The surface modification can be carried out continuously or batchwise in heatable mixers and driers having spray devices. Suitable devices may be, for example: ploughshare mixers, disk, fluidised bed or fixed bed driers.

When the heat treatment is complete, the oxides according to the invention can be ground. To this end, pinned disk, toothed disk or jet mills can be used.

As surface-modifying agents there may be used silanes from the following group:
a) organosilanes of the (RO)₃Si(CₙH₂ₙ₊₁) and (RO)₃Si (CₙH₂ₙ₋₁) type
   R=alkyl, for example methyl, ethyl, n-propyl, isopropyl, butyl
   n=1-20
b) organosilanes of the R′ₓ(RO)_{y}Si(CₙH₂ₙ₊₁) and
   R′x(RO)ySi(CₙH₂ₙ₋₁) type
   R=alkyl, for example methyl, ethyl, n-propyl, isopropyl, butyl
   R′=alkyl, for example methyl, ethyl, n-propyl, isopropyl, butyl
   R′=cycloalkyl
   n=1-20
   x+y=3
   x=1, 2
   y=1, 2
c) haloorganosilanes of the X₃Si(CₙH₂ₙ₊₁) and X₃Si(CₙH₂ₙ₋₁) type
   X=Cl, Br
   n=1-20
d) haloorganosilanes of the X₂(R′)Si(CₙH₂ₙ₊₁) and
   X₂(R′)Si(CₙH₂ₙ₋₁) type
   X=Cl, Br
   R′=alkyl, for example methyl, ethyl, n-propyl, isopropyl, butyl
   R′=cycloalkyl
   n=1-20
e) haloorganosilanes of the X(R′)₂Si(CₙH₂ₙ₊₁) and
   X(R′)₂Si(CₙH₂ₙ₋₁) type
   X=Cl, Br
   R′=alkyl, for example methyl, ethyl, n-propyl, isopropyl, butyl
   R′=cycloalkyl
   n=1-20
f) organosilanes of the (RO)₃Si(CH₂)ₙ—R′ type
   R=alkyl, such as methyl, ethyl, propyl
   m=0.1-20
   R′=methyl, aryl (for example —C₆H₅, substituted phenyl radicals)
      —C₄F₉, OCF₂—CHF—CF₃, —C₆F₁₃, —O—CF₂—CHF₂
      —NH₂, —N₃, —SCN, —CH═CH₂, —NH—CH₂—CH₂—NH₂,
      —N—(CH₂—CH₂—NH₂)₂
      —OOC(CH₃)C═CH₂
      —OCH₂—CH(O)CH₂
      —NH—CO—N—CO—(CH₂)₅
   —NH—COO—CH₃, —NH—COO—CH₂—CH₃, —NH—(CH₂)₃Si(OR)₃
      —Sₓ—(CH₂)₃Si(OR)₃
      —SH
      —NR′R″R″′(R′=alkyl, aryl; R″=H, alkyl, aryl; R″′=H, alkyl, aryl, benzyl, C₂H₄NR″″R″″′ where R″″=H, alkyl and R′″″═H, alkyl)
g) organosilanes of the (R″)ₓ(RO)_{y}Si(CH₂)ₘ—R′ type
   R″=alkyl x+y=3
      =cycloalkyl x=1, 2
         y=1, 2
         m=from 0.1 to 20
   R′=methyl, aryl (for example —C₆H₅, substituted phenyl radicals)
      —C₄F₉, —OCF₂—CHF—CF₃, —C₆F₁₃, —O—CF₂—CHF₂
      —NH₂, —N₃, —SCN, —CH═CH₂, —NH—CH₂—CH₂—NH₂,
      —N—(CH₂—CH₂—NH₂)₂
      —OOC(CH₃)C═CH₂
      —OCH₂—CH(O)CH₂
      —NH—CO—N—CO—(CH₂)₅
      —NH—COO—CH₃, —NH—COO—CH₂—CH₃, —NH—(CH₂)₃Si(OR)₃
      —Sₓ—(CH₂)₃Si(OR)₃
      —SH
      —NR′R″R″′(R′=alkyl, aryl; R″=H, alkyl, aryl; R″′=H, alkyl, aryl, benzyl, C₂H₄NR″″ R″″′ where R″″=H, alkyl and R″″′=H, alkyl)
h) haloorganosilanes of the X₃Si(CH₂)ₙ—R′ type
   X=Cl, Br
   m=0.1-20
   R′=methyl, aryl (for example —C₆H₅, substituted phenyl radicals)
      —C₄F₉, —OCF₂—CHF—CF₃, —C₆F₁₃, —O—CF₂—CHF₂
      —NH₂, —N₃, —SCN, —CH═CH₂,
      —NH—CH₂—CH₂—NH₂
      —N—(CH₂—CH₂—NH₂)₂
      —OOC(CH₃)C═CH₂
      —OCH₂—CH(O)CH₂
      —NH—CO—N—CO—(CH₂)₅
      —NH—COO—CH₃, —NH—COO—CH₂—CH₃, —NH—(CH₂)₃Si(OR)₃
      —Sₓ—(CH₂)₃Si(OR)₃
      —SH
i) haloorganosilanes of the (R)X₂Si(CH₂)ₘ—R′ type
   X=Cl, Br
   R=alkyl, such as methyl, ethyl, propyl
   m=0.1-20
   R′=methyl, aryl (e.g. —C₆H₅, substituted phenyl radicals)
      —C₄F₉, —OCF₂—CHF—CF₃, —C₆F₁₃, —O—CF₂—CHF₂
      —NH₂, —N₃, —SCN, —CH═CH₂, —NH—CH₂—CH₂—NH₂,
      —N—(CH₂—CH₂—NH₂)₂
      —OOC(CH₃)C═CH₂
      —OCH₂—CH(O)CH₂
      —NH—CO—N—CO—(CH₂)₅
      —NH—COO—CH₃, —NH—COO—CH₂—CH₃, —NH—(CH₂)₃Si(OR)₃, wherein R may be methyl, ethyl, propyl, butyl
      —Sₓ—(CH₂)₃Si(OR)₃, wherein R may be methyl, ethyl, propyl, butyl
      —SH
j) haloorganosilanes of the (R)₂X Si(CH₂)ₙ—R′ type
   X=Cl, Br
   R=alkyl
   m=0.1-20
   R′=methyl, aryl (e.g. —C₆H₅, substituted phenyl radicals)
      —C₄F₉, —OCF₂—CHF—CF₃, —C₆F₁₃, —O—CF₂—CHF₂
      —NH₂, —N₃, —SCN, —CH═CH₂, —NH—CH₂—CH₂—NH₂,
      —N—(CH₂—CH₂—NH₂)₂
      —OOC(CH₃)C═CH₂
      —OCH₂—CH(O)CH₂
      —NH—CO—N—CO—(CH₂)₅
      —NH—COO—CH₃, —NH—COO—CH₂—CH₃, —NH—(CH₂)₃Si(OR)₃
      —Sₓ—(CH₂)₃Si(OR)₃
      —SH
k) silazanes of the

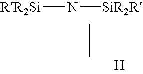

type
R=alkyl, vinyl, aryl
R′=alkyl, vinyl, aryl
l) cyclic polysiloxanes of type D 3, D 4, D 5, wherein D 3, D 4 and D 5 are understood as being cyclic polysiloxanes having 3, 4 or 5 units of the —O—Si(CH₃)₂— type.
   E.g. octamethylcyclotetrasiloxane=D 4

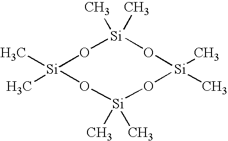

m) polysiloxanes, or silicone oils, of type

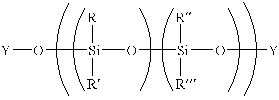

m=0, 1, 2, 3, . . . ∞
n=0, 1, 2, 3, . . . ∞
u=0, 1, 2, 3, . . . ∞
Y═CH₃, H, CₙH₂ₙ₊₁ n=1-20
Y═Si(CH₃)₃, Si(CH₃)₂H
Si(CH₃)₂OH, Si(CH₃)₂(OCH₃)
Si(CH₃)₂(CₙH₂ₙ₊₁) n=1-20
R=alkyl, such as CₙH₂ₙ₊₁, wherein n is from 1 to 20, aryl, such as phenyl and substituted phenyl radicals, (CH₂)ₙ—NH₂, H
R′=alkyl, such as CₙH₂ₙ₊₁, wherein n is from 1 to 20, aryl, such as phenyl and substituted phenyl radicals, (CH₂)ₙ—NH₂, H
R″=alkyl, such as CₙH₂ₙ₊₁, wherein n is from 1 to 20, aryl, such as phenyl and substituted phenyl radicals, (CH₂)ₙ—NH₂, H
R′″=alkyl, such as CₙH₂ₙ₊₁, wherein n is from 1 to 20, aryl, such as phenyl and substituted phenyl radicals, (CH₂)ₙ—NH₂, H

Furtheron the organosilane surface-modifying agent of the general formula I or a silane formed by the partial hydrolysis and condensation of a silane of formula I:

Si(OR)ₓ(OR′)_{y}(OR″)ᵤ(OR″′)ᵥ (I)

wherein:

### X=0, 1, 2, 3, 4

y=0, 1, 2, 3, 4
u=0, 1, 2, 3, 4
v=0, 1, 2, 3, 4
x+y+u+v=4 and
R, R′, R″ and R″′ are each independently a C₁-C₆ alkyl can be used. In a preferred way R, R′, R″ and R″′ can be each independently a C₁-C₁₈ alkyl.

The following reagents can preferably be used as surface-modifying agents:

propyltrimethoxysilane, propyltriethoxysilane, octyltrimethoxysilane (OCTMO), octyltriethoxysilane, hexadecyltrimethoxysilane, hexadecyltriethoxysilane and/or dimethylpolysiloxane. The use of octyltrimethoxysilane and/or octyltriethoxysilane is particularly preferred.

There may be used as starting materials preferably the titanium dioxides prepared by flame hydrolysis and coated with silicon dioxide according to WO 2004/056927.

The toner contains a plurality of toner particles. The toner particle is obtained by mixing an external additive and toner base material. The toner base material includes at least a binder resin and a colorant.

The toner base material is preferably formed employing a binder resin containing an at least ionic dissociative group in its structure. Specifically, styrene-acryl copolymer or polyester resin is preferably used.

A so-called chemical toner, prepared in an aqueous medium, is preferably used as the toner base material. When this toner base material is combined with the above resulting external additives, excellent images can be stably achieved, since characteristics and advantages exhibited by both of them complement one another.

Formation of a chemical toner is not limited to a single method, but an emulsion association method of forming the chemical toner is specifically preferred. Further, the binder resin is preferably obtained by copolymerizing acrylic acid or methacrylic acid as a polymerizable monomer containing an ionic dissociative group of 1-10% by weight.

In the present invention, the amount of external additives added to a toner base material is preferably 0.1-6% by weight, preferably 0.2 to 2% by weight, based on the toner base material.

Various commonly known mixers such as a tabular mixer, a HENSCHEL MIXER, a tauner mixer and a V-type mixer can be employed as the apparatus for mixing external additives with the toner base material.

In the present invention, an admixture of commonly known external additives and the external additive of the present invention may also be used.

Inorganic fine particles used as commonly known external additives can be provided. Specifically, fine silica particles, fine titanium particles, and fine alumina particles are preferably used. These fine inorganic particles are preferably hydrophobic.

Spherical organic particles of a number average primary particle diameter of approximately 10-2,000 nm can be provided as the fine organic particles which are used as the external additive. Polystyrene, polymethyl methacrylate, or a co-polymer of styrene-methyl methacrylate is provided as the fine organic particle constituent material.

In the present invention, it is preferable that the toner satisfies at least one of following structures: 1) a difference in increased charging amount between at an initial stage and at a stage after completion of 50,000 sheets of printing at low-temperature and humidity of 10° C. and 20% RH is less than 6.0 μC/g; 2) lowering in image density between at an initial stage and at a stage after completion of 50,000 sheets of printing at low-temperature and humidity of 10° C. and 20% RH is less than 0.04; 3) lowering in charging amount between at an initial stage and at a stage after completion of 50,000 sheets of printing at high-temperature and humidity condition of 30° C. and 85% RH is less than 6.0 μC/g; 4) a transferring ratio at high-temperature and humidity of 30° C. and 80% RH is not less than 95.0 and less than 99.0%.

The toner can be employed as a single-component developer and a double-component developer.

When the toner is used as the single-component developer, the toner is usually employed in a form of a non-magnetic single component developer or a magnetic single component developer in which the toner contains a magnetic particle having a diameter of approximately 0.1-0.5 μm, but both developers can be used.

When the toner is employed as the double-component developer by mixing with a carrier composed of magnetic particles, known metals such as iron, ferrite and magnetite and alloys of the metals with another metal such as aluminum and lead are employable. Of these, the ferrite particle is particularly preferred. The particle diameter of the above carrier is preferably 20-100 μm in median particle diameter (D₅₀), and more preferably 25-80 μm.

The particle diameter of the carrier can be measured with a laser diffraction type particle size distribution measuring apparatus “HELOS” (manufactured by Sympatec Co., Ltd.), equipped with a wet type dispersing device.

A carrier in which the magnetic particle is coated with a resin and a resin dispersed type carrier in which the magnetic particle is dispersed in a resin can preferably be used. Olefin type resins, styrene type resins, styrene-acryl type resins, silicone resins, ester type resins and fluorine-containing polymer resins are employed as the coating resin, though the resin is not specifically limited. Commonly known resins can be employed for constituting the resin dispersed type carrier without any limitation. For example, styrene-acryl resins, polyester type resins, fluorinated type resins and phenol type resins are usable. Of these, the coat carrier which is coated by styrene-acryl resin is more preferable, since protection of the releasing and durability of external additives can be obtained.

A toner of the present invention is preferably used for an image forming apparatus utilizing a developing apparatus for a magnetic single component developer, a non-magnetic single component developer, or a double-component developer. Of these, the image forming apparatus utilizing a developing apparatus for a non-magnetic single component developer or a double-component developer is more preferable.

### EXAMPLES

### 1. Surface Modification

As starting material there are used pyrogenically prepared silicon dioxide-titanium dioxide mixed oxides, which are prepared according to WO 2004/056927.

The physico-chemical data of the starting materials are shown in Table 1.

TABLE 1

| | Specific | | | | |
|---|---|---|---|---|---|
| | surface area | SiO₂ | TiO₂ | Tamped | |
| | according to | content | content | density | pH |
| Oxide | BET [m²/g] | [%] | [%] | [g/l] | value |
| 1 | 37 | 7.0 | 93.0 | 56 | 3.8 |
| 2 | 105 | 7.2 | 92.8 | 46 | 3.7 |
| 3 | 59 | 12.7 | 87.3 | 58 | 3.8 |
| 4 | 187 | 35.1 | 64.9 | 51 | 3.9 |

The following reagents can be used as surface-modifying agents:

propyltrimethoxysilane, propyltriethoxysilane, octyltrimethoxysilane (OCTMO), octyltriethoxysilane, hexadecyltrimethoxysilane, hexadecyltriethoxysilane and/or dimethylpolysiloxane. The use of octyltrimethoxysilane and/or octyltriethoxysilane is particularly preferred.
Preparation of the Surface-Modified Titanium Dioxides Coated with Silicon Dioxide—Examples

TABLE 2

| | | | Parts SM**/ | Parts H₂O/ | Tempering | Tempering |
|---|---|---|---|---|---|---|
| | | | 100 parts | 100 parts | temperature | time |
| Name | Oxide* | SM** | oxide | oxide | [° C.] | [h] |
| Example 1 | 1 | A | 5.5 | 0 | 120 | 2 |
| Example 2 | 1 | A | 10 | 0 | 120 | 2 |
| Example 3 | 2 | A | 7.8 | 3 | 120 | 2 |
| Example 4 | 2 | A | 5.2 | 3 | 120 | 2 |
| Example 5 | 2 | A | 2.6 | 3 | 120 | 2 |
| Example 6 | 2 | A | 1.8 | 3 | 120 | 2 |
| Example 7 | 2 | B | 12 | 3 | 120 | 2 |
| Example 8 | 2 | B | 14 | 3 | 120 | 2 |
| Example 9 | 2 | B | 9.4 | 3 | 120 | 2 |
| Example 10 | 2 | B | 4.7 | 3 | 120 | 2 |
| Example 11 | 3 | A | 7.8 | 3 | 120 | 2 |
| Example 12 | 3 | A | 5.0 | 3 | 120 | 2 |
| Example 13 | 3 | A | 1.7 | 3 | 120 | 2 |
| Example 14 | 3 | B | 14 | 3 | 120 | 2 |
| Example 15 | 3 | B | 9.3 | 3 | 120 | 2 |
| Example 16 | 3 | B | 4.5 | 3 | 120 | 2 |
| Example 17 | 4 | A | 7.2 | 3 | 120 | 2 |

SM = surface-modifying reagent
A = octyltrimethoxysilane
B = propyltrimethoxysilane

Physico-Chemical Data of the Surface-Modified Titanium Dioxides Coated with Silicon Dioxide—Examples

TABLE 3

| | Specific | | | | | |
|---|---|---|---|---|---|---|
| | surface area | Tamped | Loss on | Ignition | C | |
| | according to | density | drying | loss | content | pH |
| Name | BET [m²/g] | [g/l] | [%] | [%] | [%] | value |
| Example 1 | 61 | 85 | 0.7 | 3.5 | 2.2 | 3.7 |
| Example 2 | 55 | 96 | 0.6 | 5.1 | 3.7 | 3.9 |
| Example 3 | 101 | 75 | 0.5 | 4.4 | 3.1 | 3.8 |
| Example 4 | 104 | 70 | 0.8 | 3.6 | 2.2 | 3.8 |
| Example 5 | 106 | 65 | 0.9 | 2.6 | 1.5 | 3.8 |
| Example 6 | 106 | 63 | 0.6 | 2.2 | 1.2 | 3.8 |
| Example 7 | 95 | 79 | 0.4 | 3.7 | 2.6 | 3.8 |
| Example 8 | 90 | 79 | 0.7 | 3.8 | 3.0 | 3.8 |
| Example 9 | 98 | 76 | 0.5 | 2.9 | 2.2 | 3.8 |
| Example 10 | 102 | 69 | 0.6 | 2.3 | 1.3 | 3.8 |
| Example 11 | 73 | 83 | 0.2 | 1.9 | 0.75 | 4.2 |
| Example 12 | 52 | 80 | 0.5 | 4.0 | 3.2 | 4 |
| Example 13 | 55 | 79 | 0.6 | 3.0 | 2.1 | 3.9 |
| Example 14 | 57 | 72 | 0.7 | 1.5 | 0.8 | 6.4 |
| Example 15 | 46 | 80 | 0.5 | 3.5 | 3.1 | 3.8 |
| Example 16 | 52 | 78 | 0.5 | 3.8 | 2.1 | 3.8 |
| Example 17 | 178 | 65 | 0.5 | 2.7 | 2.7 | 3.8 |

The invention will be illustrated in greater detail with reference to the following examples, but the invention should not be construed as being limited thereto. In the following examples, all the “parts” are given by weight unless otherwise indicated.

Black Toner with Zinc Stearate Example Toner 1

A black toner is prepared by melt mixing together 5% by weight carbonblack in a propoxylated bisphenol A fumarate resin having a gel content of about 8% by weight. The toner also comprises as external surface additive package including 5.1% by weight of the powder according to example 2 (see table 3) and 0.5% by weight zinc stearate L available from Ferro Corporation.

Black Toner with Calcium Stearate Example Toner 2-6

Black toners are prepared as in example 1, expect that the external surface additive package is changed. In these formulations, the externals surface additive package includes 4.3% by weight oxide of the powder according to example 13 (see table 3), and varying amounts of calcium stearate. The amounts of calcium stearate used are 0 wt. % (example 2), 0.05 wt. % (example 3), 0.1 wt. % (example 4), 0.25 wt. % (example 5) and 0.5 wt. % (example 6).

### Preparation of Toner Base Material

After premixing 100 parts by weight of styreneacrylic resin having two peak molecular weight distributions as a binder resin, 4 parts by weight of low molecular weight of carbon black, they were melted and mixed with a twin screw extruder, and what was obtained after a cooling-solidification process was pulverized and then classified to prepare toner base material 2. In addition, median particle diameter (D₅₀) of this toner base materials was 7.1 μm.

### Preparation of Toner

1.0 parts by weight of the foregoing external additive according to Example 1, Table 3 was added into 100 parts by weight of the above toner base materials, and a mixing process was conducted with a Henschel-Mixer manufactured by Mitsui Miike Co., Ltd. Subsequently, coarse particles were removed using a sieve of 45 μm.

As is also clear from example above, toner containing external additives according to the invention can exhibit no variation in charging via the installation environment as well as variation in temperature and humidity in the interior of an apparatus (including the severe environment such as high-temperature and humidity and low-temperature and humidity). As a result, the predetermined image density can be obtained to achieve stable image formation under the severe environment such as high-temperature and humidity and low-temperature and humidity.

The above external additives applied to a toner of a small particle diameter make it possible to provide an electrostatic charge image developing toner. As a result, stable image formation with no occurrence of toner “packing” can be provided for users who do not operate printers for a comparatively long period of time at home or in small offices. For example, a given amount of toner can be transported during printing at any time, so that low density in prepared prints, caused by toner transport problems or insufficient supply of toner, is not generated, and the predetermined density can be obtained to achieve stable image formation. A toner of a small particle diameter also makes it possible to form a stable toner image exhibiting high-resolution.

The present toner is specifically capable of providing a simple and compact printer with no increase in the number of parts as well as with no complicated structure to form stable image formation, and printing in high resolution which used to be difficult can be carried out easily by a compact type printer operating at low cost.

1. An electrostatic charge image developing toner containing external additives comprising pyrogenically prepared surface modified silicon dioxide-titanium dioxide mixed oxides.

2. The electrostatic charge image developing toner of claim 1, wherein an amount of the external additives added to a toner base material is 0.1-6% by weight, based on the toner base material.

3. The electrostatic charge image developing toner of claim 1, wherein the pyrogenically prepared surface-modified silicondioxide-titanium dioxide mixed oxide is prepared by a surface modified, pyrogenically prepared titanium dioxides coated with silicon dioxide.

4. The electrostatic charge image developing toner of claim 3, wherein the surface-modified, pyrogenically prepared titanium dioxides coated with silicon dioxide is prepared by spraying titanium dioxides prepared by flame hydrolysis and coated with silicon dioxide with the surface-modifying agent and tempering the surface modified silicon dioxide coated titanium dioxides.

5. The electrostatic charge image developing toner of claim 3, wherein the surface-modified, pyrogenically prepared titanium dioxides coated with silicon dioxide comprising treating the titanium dioxides prepared by flame hydrolysis and coated with silicon dioxide with the surface-modifying agent in vapour form and then heat treated.
